(19) United States
(12) Patent Application Publication
(10) Pub. No.: US 2022/0101266 A1
(43) Pub. Date: Mar. 31, 2022

(54) Intelligent Sabbatical Management

(71) Applicant: ADP, LLC, Roseland, NJ (US)

(72) Inventors: Roberto Silveira, Porto Alegre (BR); Juliana Beber, Porto Alegre (BR); Guilherme Gomes, Porto Alegre (BR); Veronica Mendes, Porto Alegre (BR); Bruno Apel, Porto Alegre (BR); Jarismar Silva, Porto Alegre (BR); Roberto Dias, Porto Alegre (BR); Vincent Kellers, Porto Alegre (BR); Juliana Cassuli, Porto Alegre (BR)

(21) Appl. No.: 17/038,140

(22) Filed: Sep. 30, 2020

(51) Int. Cl. G06Q 10/10; G06Q 10/06; G06Q 20/10; G06Q 20/08; G06N 20/00

(52) U.S. Cl. CPC G06Q 10/1057; G06Q 10/063116; G06N 20/00; G06Q 20/102; G06Q 20/0855; G06Q 10/1093

(57) ABSTRACT

Intelligent management of employee sabbaticals is provided. An analysis of a profile of an employee requesting a sabbatical along with historical data and profiles corresponding to other employees of an employer is performed using an artificial intelligence component. Proposed sabbatical plan options for the employee are generated using the artificial intelligence component based on the analysis of the profile of the employee and the historical data and profiles corresponding to the other employees of the employer. Selections from the proposed sabbatical plan options by the employee are received via a sabbatical planner graphical user interface displayed on a client device of the employee. A sabbatical plan for the employee is generated using the artificial intelligence component based on the selections from the proposed sabbatical plan options by the employee. A set of action steps corresponding to the sabbatical for the employee is performed.

### BACKGROUND

### 1. Field

The disclosure relates generally to artificial intelligence and more specifically to generating an intelligent employee sabbatical plan using an artificial intelligence component.

### 2. Description of the Related Art

Artificial intelligence is an ability of a computer to perform tasks commonly associated with human intelligence, such as visual perception, speech recognition, decision-making, and the like. Artificial intelligence is frequently applied to systems endowed with intellectual processes, such as an ability to reason, discover meaning, generalize, and learn from past experience. Since the development of computers, it has been demonstrated that computers can be programmed to carry out very complex tasks.

Traditional goals of artificial intelligence include statistical analysis, perception, reasoning, knowledge representation, planning learning, natural language processing, and the like. Natural language processing allows computers to read and understand human language. Some applications of natural language processing include information retrieval, text mining, question answering, and machine translation.

Machine learning is also a fundamental concept of artificial intelligence. Machine learning improves automatically through experience. Unsupervised machine learning is an ability to find patterns in a stream of input, without requiring a human to label the inputs first. Supervised machine learning includes both classification and regression, which requires a human to label the input data first, known as training data, in order to make predictions or decisions without being explicitly programmed to do so. Classification is used to determine what category something belongs in, and occurs after a machine learning program sees a number of examples of things from several categories. Regression is the attempt to produce a function that describes the relationship between inputs and outputs and predicts how the outputs should change as the inputs change. In its application across business problems, machine learning is also referred to as predictive analytics.

### SUMMARY

According to one illustrative embodiment, a computer-implemented method for intelligent management of employee sabbaticals is provided. The computer, using an artificial intelligence component, performs an analysis of a profile of an employee requesting a sabbatical along with historical data and profiles corresponding to other employees of an employer. The computer, using the artificial intelligence component, generates proposed sabbatical plan options for the employee based on the analysis of the profile of the employee and the historical data and profiles corresponding to the other employees of the employer. The computer receives selections from the proposed sabbatical plan options by the employee via a sabbatical planner graphical user interface displayed on a client device of the employee. The computer, using the artificial intelligence component, generates a sabbatical plan for the employee based on the selections from the proposed sabbatical plan options by the employee. The computer performs a set of action steps corresponding to the sabbatical for the employee.

According to another illustrative embodiment, a computer system for intelligent management of employee sabbaticals is provided. The computer system comprises a bus system, a storage device storing program instructions connected to the bus system, and a processor executing the program instructions connected to the bus system. The computer system, using an artificial intelligence component, performs an analysis of a profile of an employee requesting a sabbatical along with historical data and profiles corresponding to other employees of an employer. The computer system, using the artificial intelligence component, generates proposed sabbatical plan options for the employee based on the analysis of the profile of the employee and the historical data and profiles corresponding to the other employees of the employer. The computer system receives selections from the proposed sabbatical plan options by the employee via a sabbatical planner graphical user interface displayed on a client device of the employee. The computer system, using the artificial intelligence component, generates a sabbatical plan for the employee based on the selections from the proposed sabbatical plan options by the employee. The computer system performs a set of action steps corresponding to the sabbatical for the employee.

According to another illustrative embodiment, a computer program product for intelligent management of employee sabbaticals is provided. The computer program product comprises a computer readable storage medium having program instructions embodied therewith, the program instructions executable by a computer to cause the computer to perform a method. The computer, using an artificial intelligence component, performs an analysis of a profile of an employee requesting a sabbatical along with historical data and profiles corresponding to other employees of an employer. The computer, using the artificial intelligence component, generates proposed sabbatical plan options for the employee based on the analysis of the profile of the employee and the historical data and profiles corresponding to the other employees of the employer. The computer receives selections from the proposed sabbatical plan options by the employee via a sabbatical planner graphical user interface displayed on a client device of the employee. The computer, using the artificial intelligence component, generates a sabbatical plan for the employee based on the selections from the proposed sabbatical plan options by the employee. The computer performs a set of action steps corresponding to the sabbatical for the employee.

According to another illustrative embodiment, a method for intelligent management of employee sabbaticals is provided. An analysis is performed of a profile of an employee requesting a sabbatical along with historical data and profiles corresponding to other employees of an employer. Proposed sabbatical plan options are generated for the employee based on the analysis of the profile of the employee and the historical data and profiles corresponding to the other employees. Selections are received from the proposed sabbatical plan options by the employee. A sabbatical plan is generated for the employee based on the selections from the proposed sabbatical plan options by the employee.

### BRIEF DESCRIPTION OF THE DRAWINGS

FIG. 1 is a pictorial representation of a network of data processing systems in which illustrative embodiments may be implemented;

FIG. 2 is a diagram of a data processing system in which illustrative embodiments may be implemented;

FIG. 3 is a diagram illustrating an example of a sabbatical management system in accordance with an illustrative embodiment;

FIG. 4 is a diagram illustrating an example of a sabbatical explore screen of a sabbatical planner graphical user interface in accordance with an illustrative embodiment;

FIG. 5 is a diagram illustrating an example of a sabbatical configuration screen of the sabbatical planner graphical user interface in accordance with an illustrative embodiment; and

FIGS. 6A-6B are a flowchart illustrating a process for managing employee sabbaticals in accordance with an illustrative embodiment.

### DETAILED DESCRIPTION

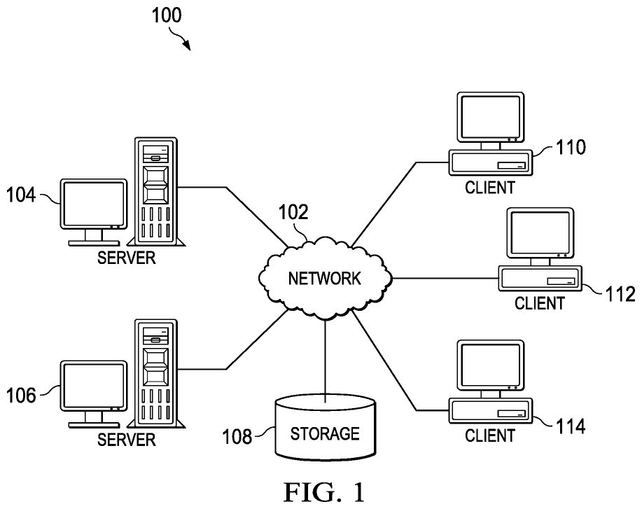

With reference now to the figures, and in particular, with reference to FIGS. 1-3, diagrams of data processing environments are provided in which illustrative embodiments may be implemented. It should be appreciated that FIGS. 1-3 are only meant as examples and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers, data processing systems, and other devices in which the illustrative embodiments may be implemented. Network data processing system 100 contains network 102, which is the medium used to provide communications links between the computers, data processing systems, and other devices connected together within network data processing system 100. Network 102 may include connections, such as, for example, wire communication links, wireless communication links, fiber optic cables, and the like.

In the depicted example, server 104 and server 106 connect to network 102, along with storage 108. Server 104 and server 106 may be, for example, server computers with high-speed connections to network 102. In addition, server 104 and server 106 provide intelligent employee sabbatical management services. It should be noted that server 104 and server 106 are owned and operated by a third-party entity, such as, for example, Automatic Data Processing, LLC of New Jersey, which is the provider of the intelligent employee sabbatical management services to a plurality of registered employer entities. Registered employer entities may include, for example, companies, enterprises, businesses, organizations, agencies, institutions, and the like.

Also, it should be noted that server 104 and server 106 may each represent a cluster of servers in one or more data centers. Alternatively, server 104 and server 106 may each represent multiple computing nodes in one or more cloud environments. Further, server 104 and server 106 may provide information, such as, for example, applications, programs, files, data, and the like to client 110, client 112, and client 114.

Client 110, client 112, and client 114 also connect to network 102. In this example, clients 110, 112, and 114 correspond to a particular employer entity and are registered clients of server 104 and server 106. The employer entity employs a multitude of employees consisting of different types of employees, such as, for example, laborers, workers, administrative staff, managers, supervisors, executives, and the like.

In this example, clients 110, 112, and 114 are shown as desktop or personal computers with wire communication links to network 102. However, it should be noted that clients 110, 112, and 114 are examples only and may represent other types of data processing systems, such as, for example, laptop computers, handheld computers, smart phones, smart televisions, and the like, with wire or wireless communication links to network 102. Users of clients 110, 112, and 114 (i.e., employees of the employer) may utilize clients 110, 112, and 114 to access the intelligent employee sabbatical management services provided by server 104 and server 106.

Server 104 and server 106, using artificial intelligence, analyze information regarding a particular employee requesting sabbatical leave (e.g., profile, employment contract, human resources record, and the like, which correspond to that particular employee requesting sabbatical leave) and information contained in a plurality of different data sources (e.g., profiles, historical sabbatical plans, payroll data, benefits packages, human resources records, and the like, which correspond to other employees of the employer) to generate a set of sabbatical plan options for the requesting employee. The plurality of different data sources may include, for example, a database of the employer containing human resources records corresponding to all of the employer's employees, third-party provider databases containing other benefits, such as insurance, a database of all employee profiles, a database of all employment contracts, and the like.

Storage 108 is a network storage device capable of storing any type of data in a structured format or an unstructured format. In addition, storage 108 may represent a plurality of network storage devices. Further, storage 108 may include the plurality of different databases that contains the plurality of different employee human resources records, profiles, historical sabbatical plans, benefits packages, and the like corresponding to the plurality of different employer entities. Furthermore, storage 108 may store other types of data, such as authentication or credential data that may include user names, passwords, and biometric data associated with client device users and system administrators, for example.

In addition, it should be noted that network data processing system 100 may include any number of additional servers, clients, storage devices, and other devices not shown. For example, network data processing system 100 may include a plurality of client devices corresponding to each of the plurality of employer entities. Program code located in network data processing system 100 may be stored on a computer readable storage medium and downloaded to a computer or other data processing device for use. For example, program code may be stored on a computer readable storage medium on server 104 and downloaded to client 110 over network 102 for use on client 110.

In the depicted example, network data processing system 100 may be implemented as a number of different types of communication networks, such as, for example, an internet, a wide area network (WAN), a telecommunications network, or any combination thereof. FIG. 1 is intended as an example only, and not as an architectural limitation for the different illustrative embodiments.

As used herein, when used with reference to items, “a number of” means one or more of the items. For example, “a number of different types of communication networks” is one or more different types of communication networks. Similarly, “a set of,” when used with reference to items, means one or more of the items.

Further, the term “at least one of,” when used with a list of items, means different combinations of one or more of the listed items may be used, and only one of each item in the list may be needed. In other words, “at least one of” means any combination of items and number of items may be used from the list, but not all of the items in the list are required. The item may be a particular object, a thing, or a category.

For example, without limitation, “at least one of item A, item B, or item C” may include item A, item A and item B, or item B. This example may also include item A, item B, and item C or item B and item C. Of course, any combinations of these items may be present. In some illustrative examples, “at least one of” may be, for example, without limitation, two of item A; one of item B; and ten of item C; four of item B and seven of item C; or other suitable combinations.

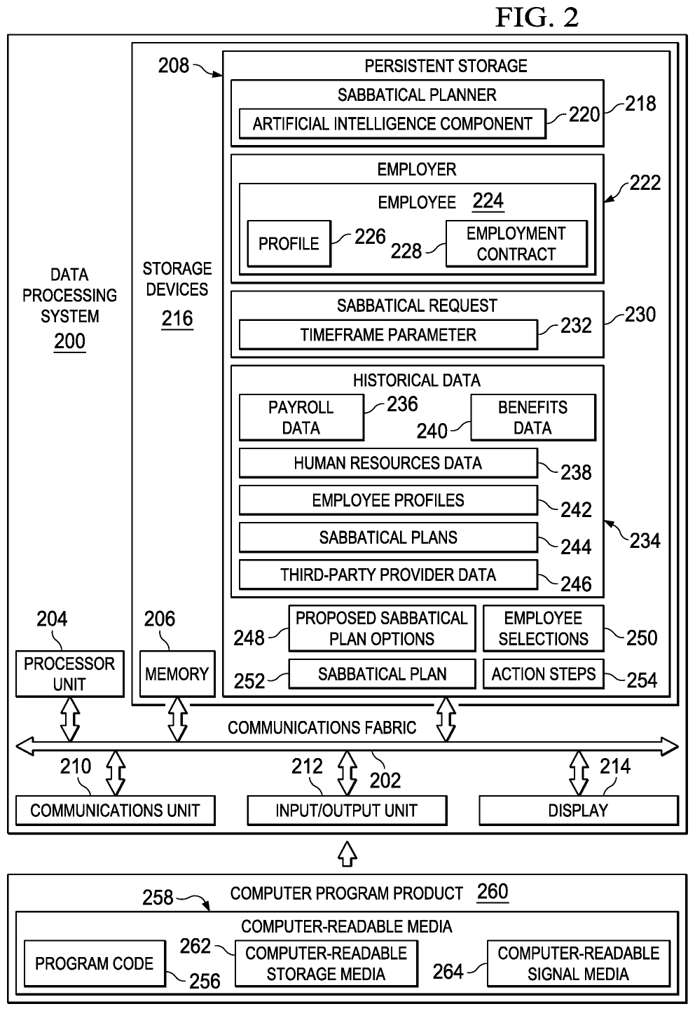

With reference now to FIG. 2, a diagram of a data processing system is depicted in accordance with an illustrative embodiment. Data processing system 200 is an example of a computer, such as server 104 in FIG. 1, in which computer readable program code or instructions implementing the intelligent employee sabbatical management processes of illustrative embodiments may be located. In this example, data processing system 200 includes communications fabric 202, which provides communications between processor unit 204, memory 206, persistent storage 208, communications unit 210, input/output (I/O) unit 212, and display 214.

Processor unit 204 serves to execute instructions for software applications and programs that may be loaded into memory 206. Processor unit 204 may be a set of one or more hardware processor devices or may be a multi-core processor, depending on the particular implementation.

Memory 206 and persistent storage 208 are examples of storage devices 216. As used herein, a computer readable storage device or computer readable storage medium is any piece of hardware that is capable of storing information, such as, for example, without limitation, data, computer readable program instructions in functional form, and/or other suitable information either on a transient basis or a persistent basis. Further, a computer readable storage device or computer readable storage medium excludes a propagation medium, such as a transitory signal. Memory 206, in these examples, may be, for example, a random-access memory (RAM), or any other suitable volatile or non-volatile storage device, such as a flash memory. Persistent storage 208 may take various forms, depending on the particular implementation. For example, persistent storage 208 may contain one or more devices. For example, persistent storage 208 may be a disk drive, a solid-state drive, a rewritable optical disk, a rewritable magnetic tape, or some combination of the above. The media used by persistent storage 208 may be removable. For example, a removable hard drive may be used for persistent storage 208.

In this example, persistent storage 208 stores sabbatical planner 218. However, it should be noted that even though sabbatical planner 218 is illustrated as residing in persistent storage 208, in an alternative illustrative embodiment sabbatical planner 218 may be a separate component of data processing system 200. For example, sabbatical planner 218 may be a hardware component coupled to communication fabric 202 or a combination of hardware and software components. In another alternative illustrative embodiment, a first set of components of sabbatical planner 218 may be located in data processing system 200 and a second set of components of sabbatical planner 218 may be located in a second data processing system, such as, for example, server 106 or client 110 in FIG. 1.

Sabbatical planner 218 controls the process of generating an intelligent sabbatical plan for a requesting employee using artificial intelligence component 220. Artificial intelligence component 220 is a system that has intelligent behavior and can be based on the function of a human brain. Artificial intelligence component 220 comprises at least one of an artificial neural network, cognitive system, Bayesian network, fuzzy logic, expert system, natural language system, or some other suitable system. Machine learning can be used to train artificial intelligence component 220. Machine learning involves inputting data to the process and allowing the process to adjust and improve the function of artificial intelligence component 220, thereby increasing the performance of data processing system 200, itself.

A machine learning model of artificial intelligence component 220 can learn without being explicitly programmed to do so. The machine learning model can learn based on training data input into the machine learning model. The machine learning model can learn using various types of machine learning algorithms. The machine learning algorithms include at least one of a supervised learning, unsupervised learning, feature learning, sparse dictionary learning, anomaly detection, association rules, or other types of learning algorithms. Examples of machine learning models include an artificial neural network, a decision tree, a support vector machine, a Bayesian network, a genetic algorithm, and other types of models. These machine learning models can be trained using data and also using active, online learning on sabbatical data to provide a desired output.

Employer 222 represents an identifier of a particular employer entity that employs a multitude of employees. However, it should be noted that employer 222 only represents one particular employer entity of a plurality of different employer entities registered for the intelligent employee sabbatical management services provided by data processing system 200, which is operated by the intelligent employee sabbatical management services provider. Employee 224 represents an identifier of a particular employee of the multitude of employees who is requesting sabbatical leave from employer 222. Profile 226 is a data file containing information regarding employee 224, such as, for example, name, identifier, work location, number of years worked for employer 222, salary, payment preference (e.g., direct bank deposit, pre-paid card, paper check, or the like), role, security level, age, gender, nationality, marital status, number of children, hobbies, memberships, social media accounts, travel preferences, and the like. Role of employee 224 is the particular position that employee 224 holds with employer 222, such as a worker, a manager, a staff member, a designer, a programmer, an engineer, a scientist, a sales person, a marketer, a researcher, or the like. Employment contract 228 is the contract of employment that employee 224 signed with employer 222. Employment contract 228 contains, for example, terms of employment, such as start date, length and type of employment, role, responsibilities, salary, payment periods, benefits (e.g., health insurance, dental insurance, life insurance, retirement plans, sabbatical plans, and the like), vacation time, sick leave, disability pay, and the like.

Sabbatical request 230 represents a request from employee 224 via a client device, such as, for example, client 114 in FIG. 1, for sabbatical leave from employer 222. Timeframe parameter 232 represents a defined period of time that employee 224 wishes to take sabbatical leave. Sabbatical planner 218 determines whether employee 224 is eligible for the sabbatical leave based on timeframe parameter 232 of sabbatical request 230 and information in profile 226 and employment contract 228 corresponding to employee 224.

Upon determining that employee 224 is eligible for the sabbatical leave, sabbatical planner 218 retrieves historical data 234 from a plurality of different data sources. It should be noted that sabbatical planner 218 retrieves the data from the plurality of different data sources via an integration application programming interface gateway using a set of defined application programming interfaces. In this example, historical data 234 includes payroll data 236, human resources data 238, benefits data 240, employee profiles 242, sabbatical plans 244, and third-party provider data 246. However, it should be noted that historical data 234 may include more or less information than shown depending on different illustrative embodiments.

Payroll data 236 represent payroll information corresponding to all employees of employer 222. Human resources data 238 represent human resources information or records corresponding to all employees of employer 222, such as names, identifiers, positions, locations, duties, start dates, lengths of employment, wages, wage increases, promotions, demotions, commendations, awards, reprimands, work attitude, employee complaints, employee suggestions, bonuses, number of vacations taken, length of vacation periods, vacation location (if available), and the like. Benefits data 240 represent benefit packages information corresponding to the different employees of employer 222. Employee profiles 242 represent a plurality of different profiles that correspond to each respective employee of employer 222 and contain information similar to that of profile 226. Sabbatical plans 244 represent previously generated sabbatical plans for different employees of employer 222 who previously had taken sabbatical leave from employer 222. Third-party provider data 246 represent information provided by third-party entities, such as travel information, airline information, hotel information, car rental information, excursion information, entertainment information, seminar information, education information, retreat information, and the like.

Based on information in historical data 234 corresponding to employees of employer 222 and information in profile 226 corresponding to employee 224, sabbatical planner 218, using artificial intelligence component 220, generates proposed sabbatical plan options 248. Proposed sabbatical plan options 248 represent different options or choices for employee 224 to select from, such as travel destinations, places to stay while traveling, educational experiences and opportunities, where to relax and recharge, and the like. Employee selections 250 represent selections made by employee 224 from proposed sabbatical plan options 248, which interest employee 224 during the sabbatical leave.

Based on employee selections 250, sabbatical planner, using artificial intelligence component 220, generates sabbatical plan 252. Sabbatical plan 252 is generated specifically for employee 224. Sabbatical plan 252 includes length of the sabbatical leave, such as number of days, weeks, months, or the like, sabbatical eligibility starting date, monthly income amount during the sabbatical period, monthly contributions to a sabbatical fund by employee 224 to obtain the desired monthly income level during the sabbatical leave, matching contributions by employer 222 to the sabbatical fund corresponding to employee 224, travel destination, airline tickets, hotel reservations, travel benefits (e.g., travel insurance, lost luggage insurance, et cetera), scheduled activities, and the like. It should be noted that employee 224 approves sabbatical plan 252 prior to sabbatical planner 218 implementing sabbatical plan 252.

Action steps 254 represent a set of one or more steps that sabbatical planner 218 can perform automatically based on sabbatical plan 252. For example, action steps 254 may include sabbatical planner 218 automatically placing a replacement job posting internally for other employees of employer 222 to fill the position of employee 224 during the sabbatical period and/or placing a job posting on an online job board externally for possible new hires to fill the position. Other action steps may include automatically issuing payment to at least one of a bank account and a pre-paid card corresponding to employee 224 during the sabbatical period in accordance with an employment contract, automatically suspending work email account and security credential corresponding to employee 224 during the sabbatical period, automatically sending alerts to appropriate personnel (e.g., human resources personnel, manager or supervisor of employee 224, co-team members of employee 224, and the like) regarding employee 224 taking sabbatical leave, and automatically coordinating and maintaining other benefits of employee 224, such as health and life insurance plans, retirement plan, stock options, and the like, during the sabbatical period.

As a result, data processing system 200 operates as a special purpose computer system in which sabbatical planner 218 in data processing system 200 enables intelligent employee sabbatical management using artificial intelligence component 220. In particular, sabbatical planner 218 transforms data processing system 200 into a special purpose computer system as compared to currently available general computer systems that do not have sabbatical planner 218.

Communications unit 210, in this example, provides for communication with other computers, data processing systems, and devices via a network, such as network 102 in FIG. 1. Communications unit 210 may provide communications through the use of both physical and wireless communications links. The physical communications link may utilize, for example, a wire, cable, universal serial bus, or any other physical technology to establish a physical communications link for data processing system 200. The wireless communications link may utilize, for example, shortwave, high frequency, ultrahigh frequency, microwave, wireless fidelity (Wi-Fi), Bluetooth® technology, global system for mobile communications (GSM), code division multiple access (CDMA), second-generation (2G), third-generation (3G), fourth-generation (4G), 4G Long Term Evolution (LTE), LTE Advanced, fifth-generation (5G), or any other wireless communication technology or standard to establish a wireless communications link for data processing system 200.

Input/output unit 212 allows for the input and output of data with other devices that may be connected to data processing system 200. For example, input/output unit 212 may provide a connection for user input through a keypad, a keyboard, a mouse, a microphone, and/or some other suitable input device. Display 214 provides a mechanism to display information to a user and may include touch screen capabilities to allow the user to make on-screen selections through user interfaces or input data, for example.

Instructions for the operating system, applications, and/or programs may be located in storage devices 216, which are in communication with processor unit 204 through communications fabric 202. In this illustrative example, the instructions are in a functional form on persistent storage 208. These instructions may be loaded into memory 206 for running by processor unit 204. The processes of the different embodiments may be performed by processor unit 204 using computer-implemented instructions, which may be located in a memory, such as memory 206. These program instructions are referred to as program code, computer usable program code, or computer readable program code that may be read and run by a processor in processor unit 204. The program instructions, in the different embodiments, may be embodied on different physical computer readable storage devices, such as memory 206 or persistent storage 208.

Program code 256 is located in a functional form on computer readable media 258 that is selectively removable and may be loaded onto or transferred to data processing system 200 for running by processor unit 204. Program code 256 and computer readable media 258 form computer program product 260. In one example, computer readable media 258 may be computer readable storage media 262 or computer readable signal media 264.

In these illustrative examples, computer readable storage media 262 is a physical or tangible storage device used to store program code 256 rather than a medium that propagates or transmits program code 256. In other words, computer readable storage media 262 exclude a propagation medium, such as transitory signals. Computer readable storage media 262 may include, for example, an optical or magnetic disc that is inserted or placed into a drive or other device that is part of persistent storage 208 for transfer onto a storage device, such as a hard drive, that is part of persistent storage 208. Computer readable storage media 262 also may take the form of a persistent storage, such as a hard drive, a thumb drive, or a flash memory that is connected to data processing system 200.

Alternatively, program code 256 may be transferred to data processing system 200 using computer readable signal media 264. Computer readable signal media 264 may be, for example, a propagated data signal containing program code 256. For example, computer readable signal media 264 may be an electromagnetic signal, an optical signal, or any other suitable type of signal. These signals may be transmitted over communication links, such as wireless communication links, an optical fiber cable, a coaxial cable, a wire, or any other suitable type of communications link.

Further, as used herein, “computer readable media 258” can be singular or plural. For example, program code 256 can be located in computer readable media 258 in the form of a single storage device or system. In another example, program code 256 can be located in computer readable media 258 that is distributed in multiple data processing systems. In other words, some instructions in program code 256 can be located in one data processing system while other instructions in program code 256 can be located in one or more other data processing systems. For example, a portion of program code 256 can be located in computer readable media 258 in a server computer while another portion of program code 256 can be located in computer readable media 258 located in a set of client computers.

The different components illustrated for data processing system 200 are not meant to provide architectural limitations to the manner in which different embodiments can be implemented. In some illustrative examples, one or more of the components may be incorporated in or otherwise form a portion of, another component. For example, memory 206, or portions thereof, may be incorporated in processor unit 204 in some illustrative examples. The different illustrative embodiments can be implemented in a data processing system including components in addition to or in place of those illustrated for data processing system 200. Other components shown in FIG. 2 can be varied from the illustrative examples shown. The different embodiments can be implemented using any hardware device or system capable of running program code 256.

In the illustrative examples, the hardware may take a form selected from at least one of a circuit system, an integrated circuit, an application specific integrated circuit (ASIC), a programmable logic device, or some other suitable type of hardware configured to perform a number of operations. With a programmable logic device, the device may be configured to perform the number of operations. The device may be reconfigured at a later time or may be permanently configured to perform the number of operations. Programmable logic devices include, for example, a programmable logic array, a programmable array logic, a field programmable logic array, a field programmable gate array, and other suitable hardware devices. Additionally, the processes may be implemented in organic components integrated with inorganic components and may be comprised entirely of organic components excluding a human being. For example, the processes may be implemented as circuits in organic semiconductors.

In another example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system.

Illustrative embodiments take into account that a competitive market currently exists for employers where any offered employee benefit counts when attracting and maintaining an employee workforce. Illustrative embodiments manage employee sabbatical benefit plans for employers. A sabbatical is a period of paid leave granted to an employee by an employer for study, travel, or any other unrelated personal activity based on a defined number of years the employee has worked for the employer. In order to guarantee payment and job stability during a sabbatical period, illustrative embodiments manage a separate employee sabbatical benefit plan, which is similar to other existing employee benefit plans, such as, for example, a pension plan, a 401(k) plan, a health insurance plan, a dental insurance plan, a life insurance plan, and the like. The sabbatical benefit plan guarantees a given amount of monthly income to the employee during the sabbatical period.

Providing employee sabbaticals is a great way for employers to recruit, develop, and retain quality employees while creating a work culture rich in energy, appreciation, and productivity. For example, sabbaticals work as an employee retention tool (i.e., the cost of keeping an employee is less than replacing an employee). Sabbaticals also show that the employer cares about the well-being of its employees by showing the employer values work/life balance. Employees are attracted to employers showing a willingness to go above and beyond in providing employee benefits, such as paid sabbaticals. Sabbaticals may also increase employee productivity because employees returning from sabbaticals are often recharged and re-invigorated. Having employees coming back with renewed vigor and enthusiasm for their jobs increases productivity. Sabbaticals may also develop work teams by providing other team members with valuable experience by filling in the gap while a team member is on sabbatical and may prevent loss of productivity to the employer. In addition, a sabbatical may provide a fresh perspective to a long-time employee by stimulating new ideas. Further, a sabbatical can prevent employee burnout. Burnout can sabotage workforce retention, which many experts claim is responsible for much of the workforce turnover.

Sabbaticals also promote transparency. It is risky for an employer to depend on one employee or a small team of employees to perform mission-critical tasks. By allowing employees to leave for extended periods of time on sabbatical, the employer will require other employees to have a comprehensive understanding of all mission-critical tasks and responsibilities. For these other employees to properly perform these mission-critical tasks and responsibilities, the employee taking sabbatical will have to demonstrate how to complete the different tasks, educate the other employees on how long specific tasks will take, update all procedures and protocols corresponding to the different tasks, and the like. This promotes a sense of transparency in a company, business, organization, agency, institution, or the like, which raises accountability between individual employees and boosts productivity.

Statistics indicate that currently thirteen percent of employers offer some type of unpaid sabbatical, while five percent of employers offer paid sabbaticals. Seventy-five percent of employees indicate that they would like to take extended leave to escape the stress of their work life. Forty-three percent of employees indicate that they believe taking a sabbatical would allow them have a better disposition (i.e., more employable to be around).

Illustrative embodiments generate and utilize an improved graphical user interface (i.e., intuitive and user-friendly), which shows, for example, employee eligibility for sabbatical leave, number of paid leave days for the sabbatical granted by the employer in accordance with the employment contract, employee monthly contribution amount to the sabbatical benefit fund, matching employer contribution amount to the sabbatical benefit fund, monthly income to be paid to the employee during the sabbatical period, and the like. The sabbatical planner graphical user interface enables the employee to adjust one or more parameters (e.g., employee monthly contribution amount to the sabbatical benefit fund, start and end dates for the sabbatical, monthly payment amount during the sabbatical, and the like) making sabbatical planning a dynamic process. Also, it should be noted that the sabbatical planner graphical user interface is fully visible by the employer (i.e., employee's manager, human resources personnel, and the like).

Illustrative embodiments populate fields of the sabbatical planner graphical user interface using information collected from a plurality of data sources, such as, for example, payroll data, human resources data, benefit packages data, employee profiles, historical employee sabbatical plans, third-party benefit provider data (e.g., insurance coverage data), and the like. In addition, illustrative embodiments utilize defined application programming interfaces to connect to and control other system, such as, for example, payroll systems, human resources systems, third-party benefits systems, and the like, for efficient sabbatical management.

The employee first logs into the sabbatical planner application of illustrative embodiments. The sabbatical planner application may be, for example, a standalone application or may be integrated into a suite of human resources applications. The sabbatical planner application presents an initial screen to the employee with all relevant employee sabbatical information, such as, for example, currently available sabbatical plans offered by the employer and optionally may present offers from third-parties of possible sabbatical opportunities that the employee can enjoy. The sabbatical planner application connects with internal employer applications and systems and third-party applications and systems via an integration application programming interface gateway, which contains the appropriate application programming interface definitions and descriptions.

If the employee decides to start a new sabbatical plan after viewing the initial screen, the employee triggers a new sabbatical plan request via the graphical user interface of the sabbatical planner application. In response to receiving the sabbatical plan request from the employee, the sabbatical planner application connects to a plurality of internal employer applications and systems to plan and organize the sabbatical for the employee. Further, this sabbatical plan request triggers an artificial intelligence component (e.g., a smart sabbatical configuration wizard), which utilizes machine learning to recommend possible sabbatical plan options and scenarios that will best fit the employee's sabbatical needs and wants. The sabbatical plan request also triggers a workflow for review and approval by the employer (e.g., the manager of the employee) so that both can best plan for the sabbatical leave by the employee and assist in finding a replacement during the employee's leave of absence. The sabbatical plan request further triggers a human resources application to determine whether the employee is currently eligible to take a sabbatical within the proposed timeframe (e.g., start and end dates) for the sabbatical.

The artificial intelligence component collects all relevant information corresponding to the employee (e.g., employee profile, employment contract, employee benefits, previously taken sabbaticals, and the like). The employee profile may contain, for example, current time with employer (i.e., number of years), wage, position, security level, age, marital status, number of children, hobbies, preferences, and the like. The artificial intelligence component analyzes and compares the collected information corresponding to the employee with profiles and historical sabbaticals corresponding to other employees to propose possible sabbatical plan options that best suit the employee's sabbatical needs or desires, such as, for example, travel destinations based on previous vacations taken by the employee or information posted on social media accounts corresponding to the employee, suggested monthly employee contributions to a sabbatical fund, suggested monthly sabbatical payment amount, and the like.

Thus, the artificial intelligence component utilizes historical data and machine learning to propose different sabbatical plan options to the employee. For example, the artificial intelligence component may utilize word embedding, sentence embedding, or contextual embedding techniques to vectorize text regarding employees to increase natural language processing performance. The artificial intelligence component may also perform regression and time series analysis to suggest employee monthly sabbatical fund contribution payments. Further, the artificial intelligence component may utilize clustering or matrix factorization (recommender systems) techniques to group similar employees together based on profile information in order to recommend sabbatical plans.

The artificial intelligence component may perform, for example, data scraping, data mining, data transformation, machine learning, and the like, to collect and analyze the employee information. Illustrative embodiments train the artificial intelligence component using the historical employee sabbatical plan information and employee profile information to create a specialized machine learning model that determines sabbatical plan options and action steps. As a result, the specialized machine learning model increases the performance and accuracy of the artificial intelligence component's analytical and predictive capabilities, thereby increasing the performance of the computer, itself.

Once the artificial intelligence component generates a sabbatical plan for the employee based on selections by the employee from the different sabbatical plan options and the employee accepts the sabbatical plan, the artificial intelligence component enters into a sabbatical plan monitoring phase. During the monitoring phase, the employee is able to review within the sabbatical planner graphical user interface monthly payments, days remaining in the sabbatical, end date for the sabbatical, and the like. Also during the monitoring phase, the employee can re-configure certain parameters of the sabbatical plan in order to modify some terms, such as monthly payment amount, and receive immediate updates to the plan regarding the changes in real time from the artificial intelligence component via the sabbatical planner graphical user interface. Furthermore, the artificial intelligence component connects to other external systems, such as a banking system, pre-paid card system, credit card system, and the like, corresponding to the employee in order to issue payment to the employee as contracted.

Thus, illustrative embodiments provide one or more technical solutions that overcome a technical problem with sabbatical management for a multitude of employees corresponding to a plurality of employers. As a result, these one or more technical solutions provide a technical effect and practical application in the field of artificial intelligence.

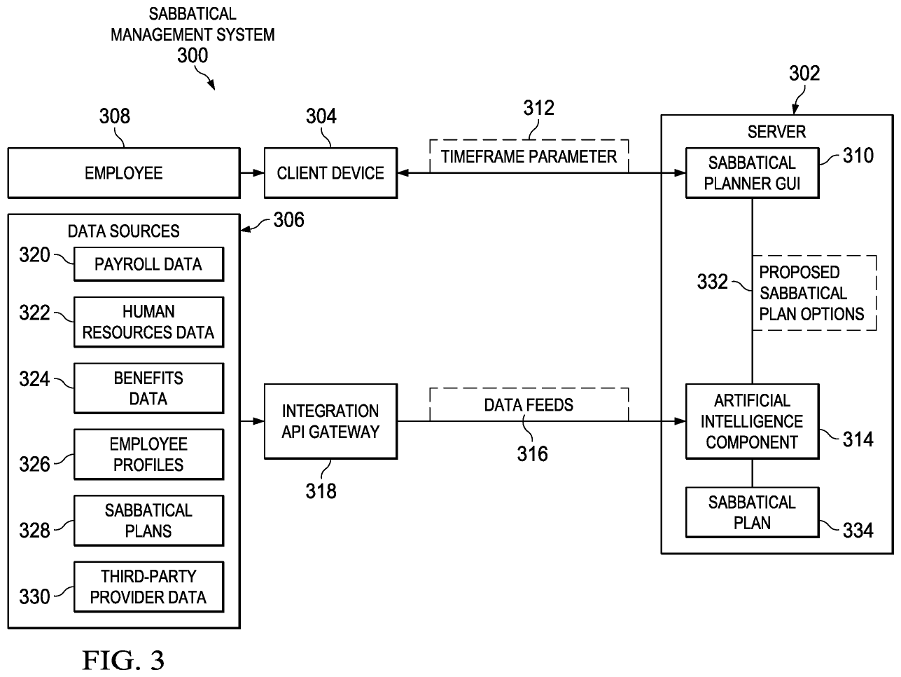

With reference now to FIG. 3, a diagram illustrating an example of a sabbatical management system is depicted in accordance with an illustrative embodiment. Sabbatical management system 300 may be implemented in a network of data processing systems, such as network data processing system 100 in FIG. 1. Sabbatical management system 300 is a system of hardware and software components for generating intelligent employee sabbatical plans for a plurality of employees using an artificial intelligence component to manage employee sabbaticals for a plurality of employers.

In this example, sabbatical management system 300 includes server 302, client device 304, and data sources 306. However, it should be noted that sabbatical management system 300 is intended as an example only and not as a limitation on illustrative embodiments. In other words, sabbatical management system 300 may include any number of servers, client devices, data sources, and other devices, components, and systems, not shown.

Server 302 may be, for example, server 104 in FIG. 1 or data processing system 200 in FIG. 2. Server 302 includes artificial intelligence component 314. Artificial intelligence component 314 may be, for example, artificial intelligence component 220 in FIG. 2.

Employee 308, via client device 304, such as client 112 in FIG. 1, submits a sabbatical request, such as sabbatical request 230 in FIG. 2, to server 302. Employee 308 is one of a multitude of employees of a particular employer entity, such as, a company, organization, institution, agency, or the like. In response to receiving the sabbatical request, server 302 generates sabbatical planner graphical user interface 310 and displays sabbatical planner graphical user interface 310 to user 308 via client device 304. Employee 308 enters timeframe parameter 312 within sabbatical planner graphical user interface 310. Timeframe parameter 312 may be, for example, timeframe parameter 232 in FIG. 2. Timeframe parameter 312 indicates when employee 308 desires to take sabbatical leave.

In response to receiving timeframe parameter 312 within sabbatical planner graphical user interface 310, server 302 utilizes artificial intelligence component 314 to collect data feeds 316 via integration application programming interface gateway 318 from data sources 306 and analyze the information included in data feeds 316. Integration application programming interface gateway 318 includes a plurality of defined application programming interfaces configured to collect the appropriate information from data sources 306. Data sources 306 include a plurality of different sources of information, both internal and external of the employer of employee 308.

In this example, data sources 306 include payroll data 320, human resources data 322, benefits data 324, employee profiles 326, sabbatical plans 328, and third-party provider data 330, such as, for example, payroll data 236, human resources data 238, benefits data 240, employee profiles 242, sabbatical plans 244, and third-party provider data 246 in FIG. 2. Payroll data 320, human resources data 322, benefits data 324, employee profiles 326, and sabbatical plans 328 represent information corresponding to employee 308 and the other employees of the employer. Third-party provider data 330 represent other benefit information provided by a set of third-party entities, such as, for example, insurance companies, travel agencies, and the like.

Based on the analysis of data feeds 316 and timeframe parameter 312, artificial intelligence component 314 determines whether employee 308 is eligible for sabbatical. In response to determining that employee 308 is eligible to take sabbatical leave, artificial intelligence component 314 populates sabbatical planner graphical user interface 310 with proposed sabbatical plan options 332, such as, for example, proposed sabbatical plan options 248 in FIG. 2. Employee 308 selects certain of proposed sabbatical plan options 248 which fit the sabbatical needs and desires of employee 308. Based on the selections by employee 308 from proposed sabbatical plan options 248, such as employee selections 250 in FIG. 2, artificial intelligence component 314 generates sabbatical plan 334, which is specific to employee 308. Sabbatical plan 334 may be, for example, sabbatical plan 252 in FIG. 2.

Artificial intelligence component 314 presents sabbatical plan 334 to employee 308 via sabbatical planner graphical user interface 310 on client device 304 for review and approval of sabbatical plan 334 by employee 308. Upon receiving an indication of approval by employee 308 of sabbatical plan 334 via sabbatical planner graphical user interface 310, artificial intelligence component 314 automatically performs a set of action steps based on employee approved sabbatical plan 334 and the timeframe of sabbatical plan 334.

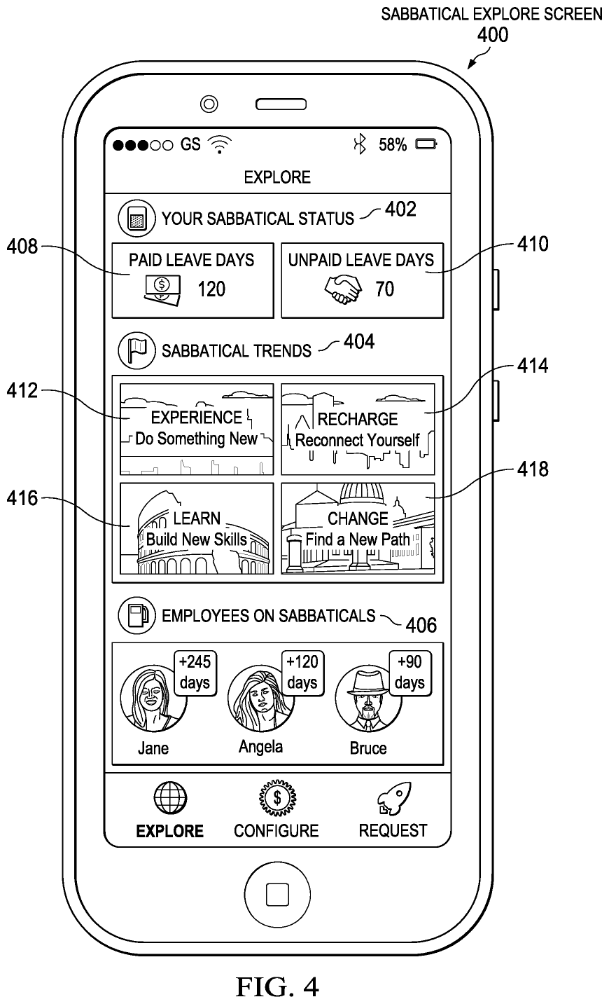

With reference now to FIG. 4, a diagram illustrating an example of a sabbatical explore screen is depicted in accordance with an illustrative embodiment. Sabbatical explore screen 400 may be implemented within a sabbatical planner graphical user interface, such as, for example, sabbatical planner graphical user interface 310 in FIG. 3. Sabbatical explore screen 400 may be, for example, an initial screen of the sabbatical planner graphical user interface, which is generated by a sabbatical planner, such as sabbatical planner 218 in FIG. 2, showing relevant sabbatical information.

In this example, sabbatical explore screen 400 includes “YOUR SABBATICAL STATUS” 402, “SABBATICAL TRENDS” 404, and “EMPLOYEES ON SABBATICAL” 406. However, it should be noted that alternative illustrative embodiments may include more or less information in sabbatical explore screen 400 than illustrated.

YOUR SABBATICAL STATUS 402 indicates the current status of a particular employee requesting sabbatical leave. In this example, YOUR SABBATICAL STATUS 402 includes “PAID LEAVE DAYS” 408 and “UNPAID LEAVE DAYS” 410. PAID LEAVE DAYS 408 indicate a number of days (120 in this example) the employer will pay the employee on sabbatical in accordance with an employment contract corresponding to the employee. UNPAID LEAVE DAYS 410 represent a number of additional days (70 in this example) the employee may stay on sabbatical without pay in accordance with the employment contract.

SABBATICAL TRENDS 404 represent current trends in sabbaticals taken by other employees. In this example, SABBATICAL TRENDS 404 include “EXPERIENCE” 412, “RECHARGE” 414, “LEARN” 416, and “CHANGE” 418. EXPERIENCE 412 indicates opportunities for the employee on sabbatical to do something new. RECHARGE 414 indicates opportunities for the employee on sabbatical to reconnect to self. LEARN 416 indicates opportunities for the employee on sabbatical to build new skills. CHANGE 418 indicates opportunities for the employee on sabbatical to find a new path.

EMPLOYEES ON SABBATICAL 406 represent a list of other employees employed by the employer who are currently on sabbatical. EMPLOYEES ON SABBATICAL 406 may also include the number of days remaining for the other employees currently on sabbatical. Further, EMPLOYEES ON SABBATICAL 406 may also include other information, such as, for example, identification of where each of the other employees currently on sabbatical are geographically located.

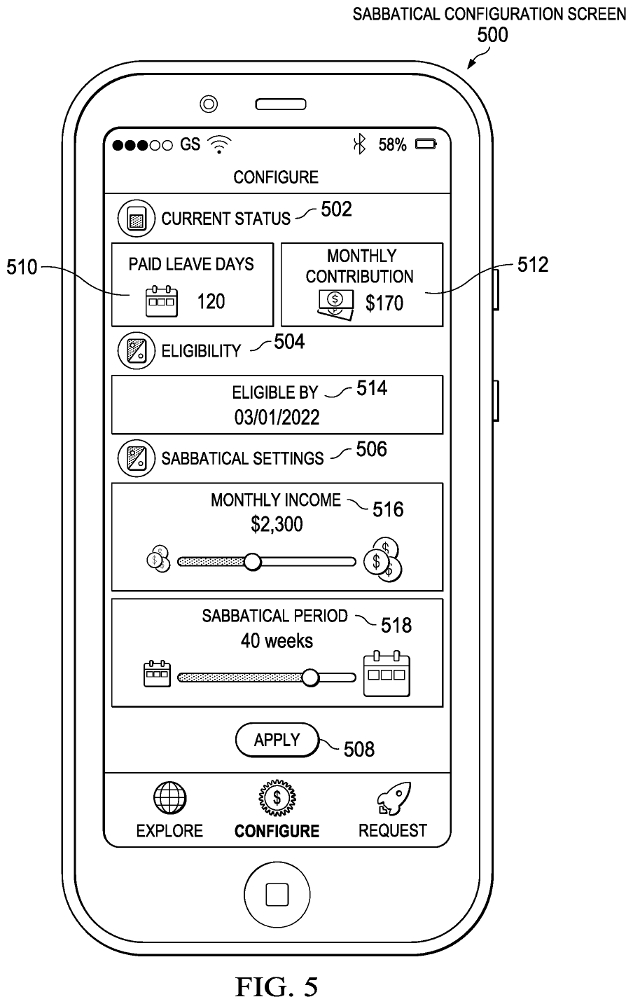

With reference now to FIG. 5, a diagram illustrating an example of a sabbatical configuration screen of the sabbatical planner graphical user interface is depicted in accordance with an illustrative embodiment. An employee after requesting a sabbatical, uses sabbatical configuration screen 500 to input or modify one or more parameters of the sabbatical plan.

In this example, sabbatical configuration screen 500 includes “CURRENT STATUS” 502, “ELIGIBILITY” 504, “SABBATICAL SETTINGS” 506, and “APPLY” button 508. However, it should be noted that alternative illustrative embodiments may include more or less information in sabbatical configuration screen 500 than shown.

In this example, CURRENT STATUS 502 includes “PAID LEAVE DAYS” 510 and “MONTHLY CONTRIBUTIONS” 512. PAID LEAVE DAYS 510 indicate the current number of paid leave days (120 in this example) granted by the employer to the employee requesting sabbatical leave in accordance with an employment contract. MONTHLY CONTRIBUTIONS 512 indicate the current monthly contributions ($170.00 in this example) made by the employee to a sabbatical fund corresponding to the employee.

In this example, ELIGIBILITY 504 includes “ELIGIBLE BY” 514. ELIGIBLE BY 514 indicates when the employee is entitled to take a sabbatical (Mar. 1, 2022 in this example).

In this example, SABBATICAL SETTINGS 506 include “MONTHLY INCOME” 516 and “SABBATICAL PERIOD” 518. It should be noted that MONTHLY INCOME 516 and SABBATICAL PERIOD 518 are adjustable by the employee via a slide button. MONTHLY INCOME 516 indicates an amount to income ($2,300.00 in this example) that the employee can expect to receive during PAID LEAVE DAYS 510. SABBATICAL PERIOD 518 indicates a defined period of time (40 weeks in this example) for the sabbatical leave. The employee utilizes APPLY button 508 to apply SABBATICAL SETTINGS 506. An artificial intelligence component, such as, for example, artificial intelligence component 314 in FIG. 3, of the sabbatical planner application configures a sabbatical plan for the employee in real time based on the information in sabbatical configuration screen 500.

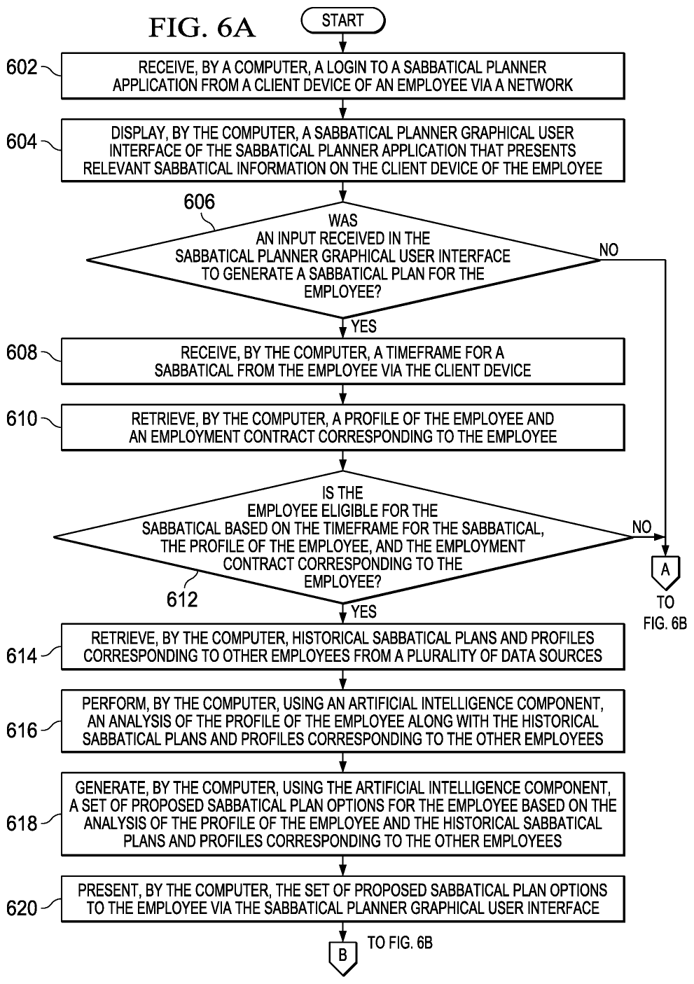

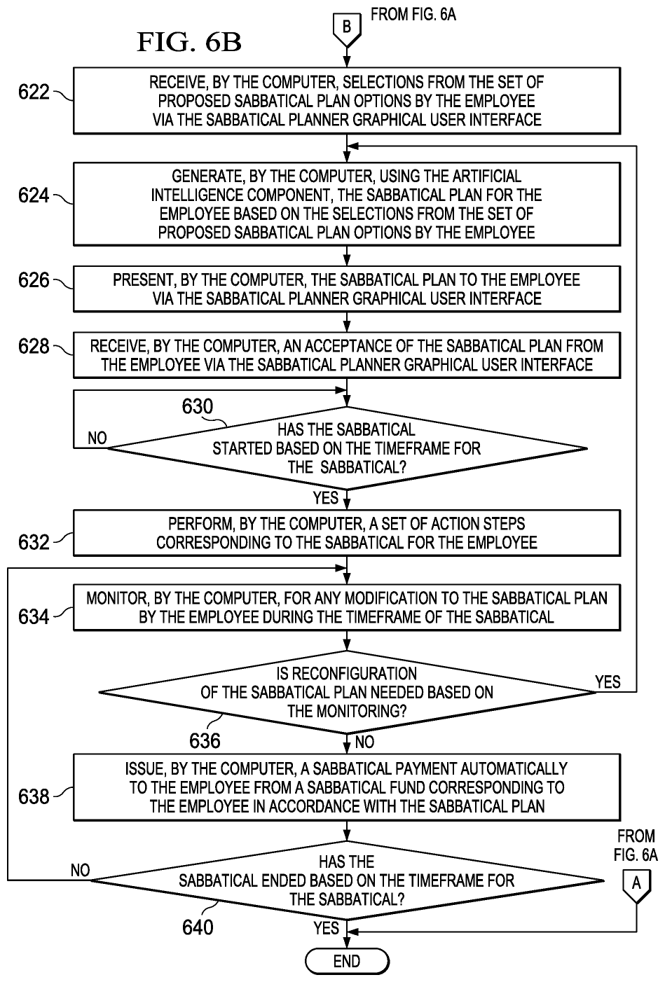

With reference now to FIGS. 6A-6B, a flowchart illustrating a process for intelligently managing employee sabbaticals is shown in accordance with an illustrative embodiment. The process shown in FIGS. 6A-6B may be implemented in a computer, such as, for example, server 104 in FIG. 1 or data processing system 200 in FIG. 2. For example, the process can be implemented in sabbatical planner 218 in FIG. 2.

The process begins when the computer receives a login to a sabbatical planner application from a client device of an employee via a network (step 602). The sabbatical planner application may be, for example, sabbatical planner 218 in FIG. 2. In response to receiving the login, the computer displays a sabbatical planner graphical user interface of the sabbatical planner application that presents relevant sabbatical information on the client device of the employee (step 604). The relevant sabbatical information may include, for example, at least one of sabbatical eligibility status of the employee, sabbatical plans of the employer, current sabbatical trends, other employees currently on sabbatical with their location and remaining days on sabbatical, and the like.

Afterward, the computer makes a determination as to whether an input was received in the sabbatical planner graphical user interface to generate a sabbatical plan for the employee (step 606). If the computer determines that an input was not received in the sabbatical planner graphical user interface to generate a sabbatical plan for the employee, no output of step 606, then the process terminates thereafter. If the computer determines that an input was received in the sabbatical planner graphical user interface to generate a sabbatical plan for the employee, yes output of step 606, then the computer receives a timeframe for a sabbatical from the employee via the client device (step 608). In addition, the computer retrieves a profile of the employee and an employment contract corresponding to the employee (step 610).

Subsequently, the computer makes a determination as to whether the employee is eligible for the sabbatical based on the timeframe for the sabbatical, the profile of the employee, and the employment contract corresponding to the employee (step 612). If the computer determines that the employee is not eligible for the sabbatical based on the timeframe for the sabbatical, the profile of the employee, and the employment contract corresponding to the employee, no output of step 612, then the process terminates thereafter. If the computer determines that the employee is eligible for the sabbatical based on the timeframe for the sabbatical, the profile of the employee, and the employment contract corresponding to the employee, no output of step 612, then the computer retrieves historical sabbatical plans and profiles corresponding to other employees from a plurality of data sources (step 614).

Further, the computer, using an artificial intelligence component, performs an analysis of the profile of the employee along with the historical sabbatical plans and profiles corresponding to the other employees (step 616). The computer, using the artificial intelligence component, generates a set of proposed sabbatical plan options for the employee based on the analysis of the profile of the employee and the historical sabbatical plans and profiles corresponding to the other employees (step 618). The computer presents the set of proposed sabbatical plan options to the employee via the sabbatical planner graphical user interface (step 620).

Afterward, the computer receives selections from the set of proposed sabbatical plan options by the employee via the sabbatical planner graphical user interface (step 622). The computer, using the artificial intelligence component, generates the sabbatical plan for the employee based on the selections from the set of proposed sabbatical plan options by the employee (step 624). The computer presents the sabbatical plan to the employee via the sabbatical planner graphical user interface (step 626). The computer also receives an acceptance of the sabbatical plan from the employee via the sabbatical planner graphical user interface (step 628).

The computer makes a determination as to whether the sabbatical has started based on the timeframe for the sabbatical (step 630). If the computer determines that the sabbatical has not started based on the timeframe for the sabbatical, no output of step 630, then the process returns to step 630 where the computer waits for the sabbatical to start. If the computer determines that the sabbatical has started based on the timeframe for the sabbatical, yes output of step 630, then the computer performs a set of action steps corresponding to the sabbatical for the employee (step 632). The set of action steps may include, for example, at least one of the computer automatically suspending work-related email accounts and security credentials corresponding to the employee while the employee is on sabbatical for security purposes, the computer automatically notifying appropriate personnel (e.g., human resources personnel, the employee's supervisor or manager, co-members of the employee's team, and the like) that the employee is on sabbatical leave and when the employee is scheduled to return, the computer automatically reassigning one or more other employees to take over work assignments of the employee on the sabbatical leave, and the computer automatically coordinating and maintaining other third-party benefits (e.g., travel, lodging, rentals, insurance plans, retirement plan, stock options, and the like) for the employee on the sabbatical leave.

Furthermore, the computer monitors for any modification to the sabbatical plan by the employee during the timeframe of the sabbatical (step 634). The computer makes a determination as to whether reconfiguration of the sabbatical plan is needed based on the monitoring (step 636). If the computer determines that reconfiguration of the sabbatical plan is needed based on the monitoring, yes output of step 636, then the process returns to step 624 where the computer generates a new sabbatical plan for the employee based on the modifications. If the computer determines that reconfiguration of the sabbatical plan is not needed based on the monitoring, no output of step 636, then the computer automatically issues a sabbatical payment to the employee from a sabbatical fund corresponding to the employee in accordance with the sabbatical plan (step 638).

Afterward, the computer makes a determination as to whether the sabbatical has ended based on the timeframe for the sabbatical (step 640). If the computer determines that the sabbatical has not ended based on the timeframe for the sabbatical, no output of step 640, then the process returns to step 634 where the computer continues to monitor for any modifications to the sabbatical plan by the employee. If the computer determines that the sabbatical has ended based on the timeframe for the sabbatical, yes output of step 640, then the process terminates thereafter.

The flowcharts and block diagrams in the different depicted embodiments illustrate the architecture, functionality, and operation of some possible implementations of apparatuses and methods in an illustrative embodiment. In this regard, each block in the flowcharts or block diagrams can represent at least one of a module, a segment, a function, or a portion of an operation or step. For example, one or more of the blocks can be implemented as program code, hardware, or a combination of the program code and hardware. When implemented in hardware, the hardware may, for example, take the form of integrated circuits that are manufactured or configured to perform one or more operations in the flowcharts or block diagrams. When implemented as a combination of program code and hardware, the implementation may take the form of firmware. Each block in the flowcharts or the block diagrams may be implemented using special purpose hardware systems that perform the different operations or combinations of special purpose hardware and program code run by the special purpose hardware.

In some alternative implementations of an illustrative embodiment, the function or functions noted in the blocks may occur out of the order noted in the figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram.

Thus, illustrative embodiments of the present invention provide a computer-implemented method, computer system, and computer program product for intelligent management of employee sabbaticals. The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for intelligent management of employee sabbaticals, the computer-implemented method comprising:
performing, by a computer, using an artificial intelligence component, an analysis of a profile of an employee requesting a sabbatical along with historical data and profiles corresponding to other employees of an employer;
generating, by the computer, using the artificial intelligence component, proposed sabbatical plan options for the employee based on the analysis of the profile of the employee and the historical data and profiles corresponding to the other employees of the employer;
receiving, by the computer, selections from the proposed sabbatical plan options by the employee via a sabbatical planner graphical user interface displayed on a client device of the employee;
generating, by the computer, using the artificial intelligence component, a sabbatical plan for the employee based on the selections from the proposed sabbatical plan options by the employee; and
performing, by the computer, a set of action steps corresponding to the sabbatical for the employee.

2. The computer-implemented method of claim 1 further comprising:
monitoring, by the computer, for modification to the sabbatical plan by the employee during a timeframe of the sabbatical; and
determining, by the computer, whether reconfiguration of the sabbatical plan is needed based on the monitoring.

3. The computer-implemented method of claim 2 further comprising:
responsive to the computer determining that reconfiguration of the sabbatical plan is needed based on the monitoring, generating, by the computer, a new sabbatical plan for the employee based on the modification.

4. The computer-implemented method of claim 2 further comprising:
responsive to the computer determining that reconfiguration of the sabbatical plan is not needed based on the monitoring, issuing, by the computer, a sabbatical payment automatically to the employee from a sabbatical fund corresponding to the employee in accordance with the sabbatical plan, wherein the computer automatically issues the sabbatical payment to at least one of a bank account and a pre-paid card corresponding to the employee.

5. The computer-implemented method of claim 1 further comprising:
presenting, by the computer, the sabbatical plan to the employee via the sabbatical planner graphical user interface displayed on the client device of the employee;
receiving, by the computer, an acceptance of the sabbatical plan from the employee via the sabbatical planner graphical user interface;
determining, by the computer, whether the sabbatical has started based on a timeframe for the sabbatical; and
responsive to the computer determining that the sabbatical has started based on the timeframe for the sabbatical, performing, by the computer, the set of action steps corresponding to the sabbatical for the employee.

6. The computer-implemented method of claim 1 further comprising:
responsive to the computer determining that an input was received in the sabbatical planner graphical user interface to generate the sabbatical plan for the employee, receiving, by the computer, a timeframe for the sabbatical from the employee via the client device;
retrieving, by the computer, the profile of the employee and an employment contract corresponding to the employee;
determining, by the computer, whether the employee is eligible for the sabbatical based on the timeframe for the sabbatical, the profile of the employee, and the employment contract corresponding to the employee; and
responsive to the computer determining that the employee is eligible for the sabbatical based on the timeframe for the sabbatical, the profile of the employee, and the employment contract corresponding to the employee, retrieving, by the computer, the historical data and profiles corresponding to the other employees.

7. The computer-implemented method of claim 1 further comprising:
receiving, by the computer, a login to a sabbatical planner application from the client device of the employee via a network; and
displaying, by the computer, the sabbatical planner graphical user interface of the sabbatical planner application that presents relevant sabbatical information on the client device of the employee, wherein the relevant sabbatical information includes at least one of sabbatical eligibility status of the employee, sabbatical plans of the employer, current sabbatical trends, and other employees currently on sabbatical with their location and remaining days on sabbatical.

8. The computer-implemented method of claim 1, wherein the action steps include at least one of the computer automatically suspending work-related accounts and credentials corresponding to the employee while the employee is on the sabbatical for security purposes, the computer automatically notifying appropriate personnel that the employee is on sabbatical leave and when the employee is scheduled to return, the computer automatically reassigning one or more other employees to take over work assignments of the employee on the sabbatical leave, and the computer automatically coordinating and maintaining other third-party benefits for the employee on the sabbatical leave.

9. The computer-implemented method of claim 1, wherein the artificial intelligence component is trained using historical information and employee profile information to create a specialized machine learning model that determines the sabbatical plan options and the set of action steps, and wherein the specialized machine learning model increases performance and accuracy regarding analytical and predictive capabilities of the artificial intelligence component thereby increasing performance of the computer, itself.

10. The computer-implemented method of claim 1, wherein the sabbatical is a period of paid leave granted to the employee by the employer based on a defined number of years the employee has worked for the employer.

11. A computer system for intelligent management of employee sabbaticals, the computer system comprising:
a bus system;
a storage device connected to the bus system, wherein the storage device stores program instructions; and
a processor connected to the bus system, wherein the processor executes the program instructions to:
perform, using an artificial intelligence component, an analysis of a profile of an employee requesting a sabbatical along with historical data and profiles corresponding to other employees of an employer;
generate, using the artificial intelligence component, proposed sabbatical plan options for the employee based on the analysis of the profile of the employee and the historical data and profiles corresponding to the other employees of the employer;
receive selections from the proposed sabbatical plan options by the employee via a sabbatical planner graphical user interface displayed on a client device of the employee;
generate, using the artificial intelligence component, a sabbatical plan for the employee based on the selections from the proposed sabbatical plan options by the employee; and
perform a set of action steps corresponding to the sabbatical for the employee.

12. The computer system of claim 11, wherein the processor further executes the program instructions to:
monitor for modification to the sabbatical plan by the employee during a timeframe of the sabbatical; and
determine whether reconfiguration of the sabbatical plan is needed based on monitoring.

13. The computer system of claim 12, wherein the processor further executes the program instructions to:
generate a new sabbatical plan for the employee based on the modification in response to determining that reconfiguration of the sabbatical plan is needed based on the monitoring.

14. The computer system of claim 12, wherein the processor further executes the program instructions to:
issue a sabbatical payment automatically to the employee from a sabbatical fund corresponding to the employee in accordance with the sabbatical plan in response to determining that reconfiguration of the sabbatical plan is not needed based on the monitoring, wherein the sabbatical payment is automatically issued to at least one of a bank account and a pre-paid card corresponding to the employee.

15. The computer system of claim 11, wherein the processor further executes the program instructions to:
present the sabbatical plan to the employee via the sabbatical planner graphical user interface displayed on the client device of the employee;
receive an acceptance of the sabbatical plan from the employee via the sabbatical planner graphical user interface;
determine whether the sabbatical has started based on a timeframe for the sabbatical; and
perform the set of action steps corresponding to the sabbatical for the employee in response to determining that the sabbatical has started based on the timeframe for the sabbatical.

16. The computer system of claim 11, wherein the processor further executes the program instructions to:
receive a timeframe for the sabbatical from the employee via the client device in response to determining that an input was received in the sabbatical planner graphical user interface to generate the sabbatical plan for the employee;
retrieve the profile of the employee and an employment contract corresponding to the employee;
determine whether the employee is eligible for the sabbatical based on the timeframe for the sabbatical, the profile of the employee, and the employment contract corresponding to the employee; and
retrieve the historical data and profiles corresponding to the other employees in response to determining that the employee is eligible for the sabbatical based on the timeframe for the sabbatical, the profile of the employee, and the employment contract corresponding to the employee.

17. The computer system of claim 11, wherein the processor further executes the program instructions to:
receive a login to a sabbatical planner application from the client device of the employee via a network; and
display the sabbatical planner graphical user interface of the sabbatical planner application that presents relevant sabbatical information on the client device of the employee, wherein the relevant sabbatical information includes at least one of sabbatical eligibility status of the employee, sabbatical plans of the employer, current sabbatical trends, and other employees currently on sabbatical with their location and remaining days on sabbatical.

18. The computer system of claim 11, wherein the action steps include at least one of the computer system automatically suspending work-related accounts and credentials corresponding to the employee while the employee is on the sabbatical for security purposes, the computer system automatically notifying appropriate personnel that the employee is on sabbatical leave and when the employee is scheduled to return, the computer system automatically reassigning one or more other employees to take over work assignments of the employee on the sabbatical leave, and the computer system automatically coordinating and maintaining other third-party benefits for the employee on the sabbatical leave.

19. The computer system of claim 11, wherein the artificial intelligence component is trained using historical information and employee profile information to create a specialized machine learning model that determines the sabbatical plan options and the set of action steps, and wherein the specialized machine learning model increases performance and accuracy regarding analytical and predictive capabilities of the artificial intelligence component thereby increasing performance of the computer system, itself.

20. The computer system of claim 11, wherein the sabbatical is a period of paid leave granted to the employee by the employer based on a defined number of years the employee has worked for the employer.

21. A computer program product for intelligent management of employee sabbaticals, the computer program product comprising a computer readable storage medium having program instructions embodied therewith, the program instructions executable by a computer to cause the computer to perform a method of:
performing, by the computer, using an artificial intelligence component, an analysis of a profile of an employee requesting a sabbatical along with historical data and profiles corresponding to other employees of an employer;
generating, by the computer, using the artificial intelligence component, proposed sabbatical plan options for the employee based on the analysis of the profile of the employee and the historical data and profiles corresponding to the other employees of the employer;
receiving, by the computer, selections from the proposed sabbatical plan options by the employee via a sabbatical planner graphical user interface displayed on a client device of the employee;
generating, by the computer, using the artificial intelligence component, a sabbatical plan for the employee based on the selections from the proposed sabbatical plan options by the employee; and
performing, by the computer, a set of action steps corresponding to the sabbatical for the employee.

22. The computer program product of claim 21 further comprising:
monitoring, by the computer, for modification to the sabbatical plan by the employee during a timeframe of the sabbatical; and
determining, by the computer, whether reconfiguration of the sabbatical plan is needed based on the monitoring.

23. The computer program product of claim 22 further comprising:
responsive to the computer determining that reconfiguration of the sabbatical plan is needed based on the monitoring, generating, by the computer, a new sabbatical plan for the employee based on the modification.

24. The computer program product of claim 22 further comprising:
responsive to the computer determining that reconfiguration of the sabbatical plan is not needed based on the monitoring, issuing, by the computer, a sabbatical payment automatically to the employee from a sabbatical fund corresponding to the employee in accordance with the sabbatical plan, wherein the computer automatically issues the sabbatical payment to at least one of a bank account and a pre-paid card corresponding to the employee.

25. The computer program product of claim 21 further comprising:
presenting, by the computer, the sabbatical plan to the employee via the sabbatical planner graphical user interface displayed on the client device of the employee;
receiving, by the computer, an acceptance of the sabbatical plan from the employee via the sabbatical planner graphical user interface;
determining, by the computer, whether the sabbatical has started based on a timeframe for the sabbatical; and
responsive to the computer determining that the sabbatical has started based on the timeframe for the sabbatical, performing, by the computer, the set of action steps corresponding to the sabbatical for the employee.

26. The computer program product of claim 21 further comprising:
responsive to the computer determining that an input was received in the sabbatical planner graphical user interface to generate the sabbatical plan for the employee, receiving, by the computer, a timeframe for the sabbatical from the employee via the client device;
retrieving, by the computer, the profile of the employee and an employment contract corresponding to the employee;
determining, by the computer, whether the employee is eligible for the sabbatical based on the timeframe for the sabbatical, the profile of the employee, and the employment contract corresponding to the employee; and
responsive to the computer determining that the employee is eligible for the sabbatical based on the timeframe for the sabbatical, the profile of the employee, and the employment contract corresponding to the employee, retrieving, by the computer, the historical data and profiles corresponding to the other employees.

27. The computer program product of claim 21 further comprising:
receiving, by the computer, a login to a sabbatical planner application from the client device of the employee via a network; and
displaying, by the computer, the sabbatical planner graphical user interface of the sabbatical planner application that presents relevant sabbatical information on the client device of the employee, wherein the relevant sabbatical information includes at least one of sabbatical eligibility status of the employee, sabbatical plans of the employer, current sabbatical trends, and other employees currently on sabbatical with their location and remaining days on sabbatical.

28. The computer program product of claim 21, wherein the action steps include at least one of the computer automatically suspending work-related accounts and credentials corresponding to the employee while the employee is on the sabbatical for security purposes, the computer automatically notifying appropriate personnel that the employee is on sabbatical leave and when the employee is scheduled to return, the computer automatically reassigning one or more other employees to take over work assignments of the employee on the sabbatical leave, and the computer automatically coordinating and maintaining other third-party benefits for the employee on the sabbatical leave.

29. The computer program product of claim 21, wherein the artificial intelligence component is trained using historical information and employee profile information to create a specialized machine learning model that determines the sabbatical plan options and the set of action steps, and wherein the specialized machine learning model increases performance and accuracy regarding analytical and predictive capabilities of the artificial intelligence component thereby increasing performance of the computer, itself.

30. The computer program product of claim 21, wherein the sabbatical is a period of paid leave granted to the employee by the employer based on a defined number of years the employee has worked for the employer.

31. A method for intelligent management of employee sabbaticals, the method comprising:
performing an analysis of a profile of an employee requesting a sabbatical along with historical data and profiles corresponding to other employees of an employer;
generating proposed sabbatical plan options for the employee based on the analysis of the profile of the employee and the historical data and profiles corresponding to the other employees;
receiving selections from the proposed sabbatical plan options by the employee; and
generating a sabbatical plan for the employee based on the selections from the proposed sabbatical plan options by the employee.
